(19) United States
(12) Patent Application Publication
(10) Pub. No.: US 2024/0135818 A1
(43) Pub. Date: Apr. 25, 2024

(54) INFORMATION PROCESSING APPARATUS, INFORMATION PROCESSING METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Yu NAGATA, Tokyo-to (JP); Ibuki SHIMADA, Miyoshi-shi (JP); Toshihiro NAKAMURA, Shizuoka-ken (JP)

(73) Assignee: TOYOTA JIDOSHA KABUSHIKI KAISHA, Toyota-shi (JP)

(21) Appl. No.: 18/489,859

(22) Filed: Oct. 18, 2023

(30) Foreign Application Priority Data
Oct. 23, 2022 (JP) 2022-170163

(51) Int. Cl. G08G 1/14; G06Q 10/02

(52) U.S. Cl. CPC G08G 1/148; G06Q 10/02; B60L 53/62

(57) ABSTRACT

An information processing apparatus includes an input interface that accepts a parking reservation for a vehicle for which parking is desired, and a controller that confirms, when the vehicle for which parking is desired is a first vehicle whose purpose for parking includes charging, whether there is an opening for reservation of a first parking lot having a charging station, completes acceptance of reservation of the first parking lot for the first vehicle when there is an opening, changes a reservation of the first parking lot for at least one second vehicle, selected based on a predetermined condition from among one or more reservation holding vehicles for which acceptance of reservation of the first parking lot is completed, to a reservation of a second parking lot based on the predetermined condition when there is no opening, and completes acceptance of reservation of the first parking lot for the first vehicle.

### CROSS-REFERENCE TO RELATED APPLICATION

This application claims priority to Japanese Patent Application No. 2022-170163 filed on Oct. 24, 2022, the entire contents of which are incorporated herein by reference.

### TECHNICAL FIELD

The present disclosure relates to an information processing apparatus, an information processing method, and a non-transitory computer readable medium.

### BACKGROUND

In recent years, technology has emerged for determining the parking lot to be assigned when a reservation for parking in a parking lot with charging stations is accepted. For example, Patent Literature (PTL) 1 discloses an operation management apparatus for accepting reservations for a first parking space with a charging station and a second parking space without a charging station, wherein after accepting a reservation for the second parking space based on a user request, in a case in which the vehicle to be parked cannot park in the second parking space, the operation management apparatus allows the vehicle to park in the first parking space if the first parking space is available.

However, when a reservation for a parking lot with charging stations is made by a vehicle for which charging is desired, the vehicle cannot park and has to wait if reservations of the parking lot are simply confirmed on a first-come, first-served basis. Demand thus exists for technology to improve the method of determining the parking lot to be assigned when a parking reservation is accepted.

### CITATION LIST

### Patent Literature

PTL 1: JP 2020-166536 A

### SUMMARY

Technology for determining the parking lot to be assigned when a parking reservation is accepted has room for improvement.

It would be helpful to improve technology for determining the parking lot to be assigned when a parking reservation is accepted.

An information processing apparatus according to an embodiment of the present disclosure is an information processing apparatus for assigning a parking lot to a vehicle, the information processing apparatus including:
an input interface configured to accept a parking reservation for a vehicle for which parking is desired; and
a controller configured to confirm, in a case in which the vehicle for which parking is desired is a first vehicle whose purpose for parking includes charging, whether there is an opening for reservation of a first parking lot having a charging station, complete acceptance of a reservation of the first parking lot for the first vehicle when there is an opening for reservation, identify, based on a predetermined condition, as a second vehicle at least one vehicle selected based on the predetermined condition from among one or more reservation holding vehicles for which acceptance of the reservation of the first parking lot is completed when there is no opening for reservation, change the reservation of the first parking lot for the second vehicle to a reservation of a second parking lot, and complete acceptance of the reservation of the first parking lot for the first vehicle.

An information processing method according to an embodiment of the present disclosure is an information processing method for assigning a parking lot to a vehicle, the information processing method including:
accepting a parking reservation for a vehicle for which parking is desired;
confirming, in a case in which the vehicle for which parking is desired is a first vehicle whose purpose for parking includes charging, whether there is an opening for reservation of a first parking lot having a charging station;
completing acceptance of a reservation of the first parking lot for the first vehicle when there is an opening for reservation;
identifying, based on a predetermined condition, as a second vehicle at least one vehicle selected based on the predetermined condition from among one or more reservation holding vehicles for which acceptance of the reservation of the first parking lot is completed when there is no opening for reservation;
changing the reservation of the first parking lot for the second vehicle to a reservation of a second parking lot; and
completing acceptance of the reservation of the first parking lot for the first vehicle.

A non-transitory computer readable medium according to an embodiment of the present disclosure stores a program configured to cause an information processing apparatus for assigning a parking lot to a vehicle to execute operations, the operations including:
accepting a parking reservation for a vehicle for which parking is desired;
confirming, in a case in which the vehicle for which parking is desired is a first vehicle whose purpose for parking includes charging, whether there is an opening for reservation of a first parking lot having a charging station;
completing acceptance of a reservation of the first parking lot for the first vehicle when there is an opening for reservation;
identifying, based on a predetermined condition, as a second vehicle at least one vehicle selected based on the predetermined condition from among one or more reservation holding vehicles for which acceptance of the reservation of the first parking lot is completed when there is no opening for reservation;
changing the reservation of the first parking lot for the second vehicle to a reservation of a second parking lot; and
completing acceptance of the reservation of the first parking lot for the first vehicle.

According to an embodiment of the present disclosure, technology for determining the parking lot to be assigned when a parking reservation is accepted is improved.

### BRIEF DESCRIPTION OF THE DRAWINGS

In the accompanying drawings:

FIG. 1 is a block diagram illustrating a schematic configuration of an information processing system according to an embodiment of the present disclosure;

FIG. 2 is a schematic diagram illustrating a configuration of a parking lot according to an embodiment of the present disclosure; and

FIG. 3 is a flowchart illustrating operations of an information processing apparatus according to an embodiment of the present disclosure.

### DETAILED DESCRIPTION

Hereinafter, an embodiment of the present disclosure will be described.

(Overview of Information Processing System)

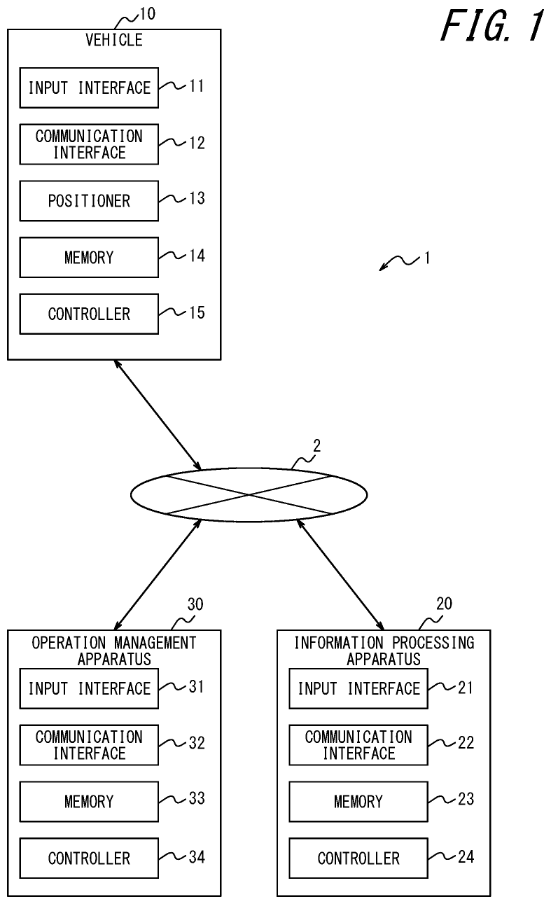

With reference to FIG. 1, an overview of the information processing system 1 according to an embodiment of the present disclosure will be described. The information processing system 1 includes a vehicle 10, an information processing apparatus 20, and an operation management apparatus 30. The vehicle 10, the information processing apparatus 20, and the operation management apparatus 30 are communicably connected to a network 2 including, for example, the Internet, a mobile communication network, and the like.

The vehicle 10 is an automobile, for example, but is not limited to this, and may be any appropriate vehicle. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The vehicle 10 may be an autonomous vehicle whose operation is managed by the operation management apparatus 30. In the present disclosure, the vehicle 10 is assumed to be an autonomous vehicle in the following description, but the vehicle 10 is not limited to autonomous vehicles.

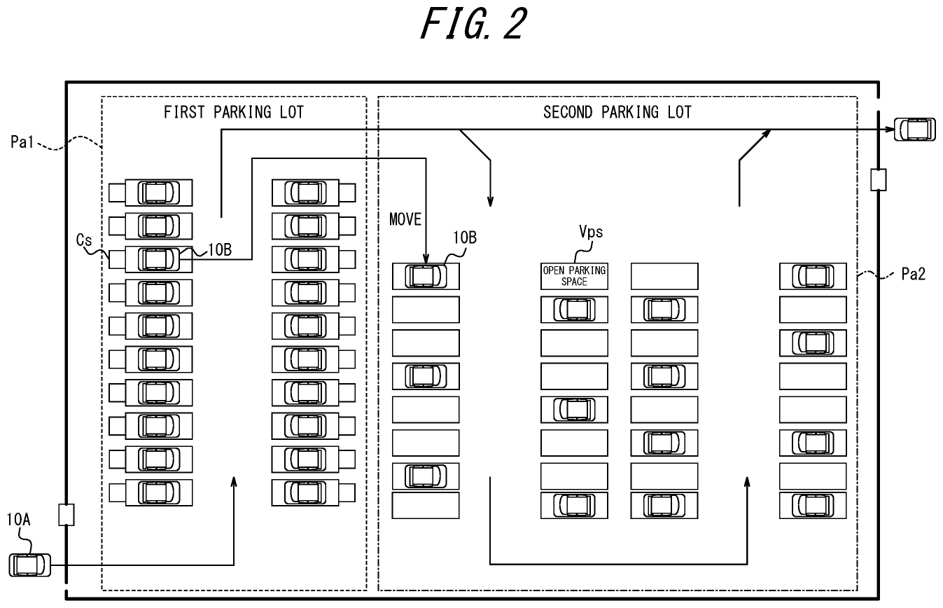

FIG. 2 is a schematic diagram illustrating a configuration of a parking lot according to an embodiment of the present disclosure. The parking lot according to the present embodiment includes, for example, a first parking lot Pa1 that has charging stations Cs and a second parking lot Pa2 that does not have charging stations Cs. A first vehicle 10A is a vehicle whose purpose for parking includes charging. The first vehicle 10A is, for example, a BEV or PHEV. The second vehicle 10B is a reservation holding vehicle for which acceptance of reservation of the first parking lot Pa1 is completed and is a vehicle whose reservation of the first parking lot Pa1 is changed to a reservation of the second parking lot Pa2, which does not have charging stations Cs, based on a predetermined condition described below. In FIG. 2, the vehicle that is moved from a parking space in the first parking lot Pa1 to a parking space in the second parking lot Pa2 corresponds to the second vehicle 10B.

The information processing apparatus 20 assigns a parking lot to a vehicle 10 for which parking is desired. The information processing apparatus 20 is, for example, a dedicated computer configured to function as a server, a general purpose personal computer, a cloud computing system, or the like. The information processing apparatus 20 can communicate with the vehicle 10 and the operation management apparatus 30 via the network 2. The information processing apparatus 20 receives, via the network 2, a parking reservation for the vehicle 10 and an operation plan, described below, which are transmitted from the operation management apparatus 30. On the other hand, the information processing apparatus 20 transmits to the operation management apparatus 30 a notification of completion of reservation of the first parking lot Pa1 or the second parking lot Pa2, a notification of change in reservation from the first parking lot Pa1 to the second parking lot Pa2, or the like.

The operation management apparatus 30 transmits the parking reservation for the vehicle 10 for which parking is desired and the operation plan for the vehicle 10 to the information processing apparatus 20. The operation management apparatus 30 receives, from the information processing apparatus 20, a notification of completion of reservation of the first parking lot Pa1 or the second parking lot Pa2, a notification of change in reservation from the first parking lot Pa1 to the second parking lot Pa2, or the like. The operation management apparatus 30 is, for example, a dedicated computer configured to function as a server, a general purpose personal computer, a cloud computing system, or the like.

The operation management apparatus 30 establishes the operation plan for the vehicle 10 (in a case in which the vehicle 10 is not an autonomous vehicle, the vehicle 10 itself may establish the operation plan). The operation plan is information that includes, for example, the vehicle size (such as small passenger car, medium passenger car, large passenger car, bus, or truck), a desired parking time slot, a purpose for parking (such as inspection, standby, maintenance, or charging), an operation route, an expected number of passengers, a vehicle weight, an expected remaining charge, or an expected power consumption. The expected remaining charge is the expected value of the remaining charge at the scheduled time for start of parking of each vehicle 10. The expected power consumption is the electrical energy expected to be consumed within a predetermined period (such as within a period from the scheduled time for the end of parking until 24:00 on the day after the end of parking) after the scheduled time for end of parking of each vehicle 10. The operation route is the route over which the operation management apparatus 30 operates the vehicle 10. In a case in which the vehicle 10 is a route bus, the operation management apparatus 30 transmits the operation route (operation schedule) to the vehicle 10.

First, an outline of the present embodiment will be described, and details thereof will be described later. In a case in which the vehicle 10 for which parking is desired is a first vehicle 10A whose purpose for parking includes charging, the information processing apparatus 20 forming part of the information processing system 1 confirms whether there is an opening for reservation of the first parking lot Pa1 that has charging stations Cs, completes acceptance of reservation of the first parking lot Pa1 for the first vehicle 10A when there is an opening for reservation, and identifies at least one vehicle, selected based on a predetermined condition from among one or more reservation holding vehicles for which acceptance of the reservation of the first parking lot Pa1 is completed, as a second vehicle 10B when there is no opening for reservation. The information processing apparatus 20 then changes a reservation of the first parking lot Pa1 for the second vehicle 10B to a reservation of the second parking lot Pa2 and completes acceptance of reservation of the first parking lot Pa1 for the first vehicle 10A.

In this way, the information processing apparatus 20 can assign vehicles whose purpose is only inspection or standby, or vehicles with low priority for charging, along with vehicles with high priority for charging to the most appropriate parking lot at the time of reservation. Therefore, compared to the case in which a reservation of the first parking lot Pa1 that has charging stations Cs is determined simply on a first-come, first-served basis for vehicles 10 for which parking reservations are accepted, the probability of inconveniences is reduced, such as waiting time occurring because a vehicle with a high priority for charging cannot park in the first parking lot Pa1 that has charging stations. In this respect, the technology for determining the parking lot to assign when a parking reservation is accepted is improved.

Next, configurations of the information processing system 1 will be described in detail.

(Configuration of Vehicle)

As illustrated in FIG. 1, the vehicle 10 includes an input interface 11, a communication interface 12, a positioner 13, a memory 14, and a controller 15.

The input interface 11 is configured to include at least one interface for input that is capable of accepting an input from the driver of the vehicle 10. The interface for input is, for example, a physical key, a capacitive key, a pointing device, a touch screen integrally provided with the display, a barcode reader, an IC card reader, a microphone, or the like. However, the interface for input is not limited to this.

The communication interface 12 includes at least one interface for communication for connecting to the network 2. The communication interface is compliant with a communication standard such as the 4th generation (4G) standard or the 5th generation (5G) standard, or a Controller Area Network (CAN) standard, for example, but is not limited to these. In the present embodiment, the vehicle 10 communicates with the operation management apparatus 30 and the information processing apparatus 20 via the communication interface 12 and the network 2.

The positioner 13 includes one or more apparatuses configured to acquire positional information for the vehicle 10. Specifically, the positioner 13 includes, for example, a receiver compliant with GPS, but is not limited to this example and may include a receiver compliant with any appropriate satellite positioning system.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information used for operations of the vehicle 10. For example, the memory 14 may store a system program, an application program, embedded software, operation plans received from the operation management apparatus 30, and the like. The information stored in the memory 14 may be updated with, for example, information acquired from the network 2 via the communication interface 12.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire vehicle 10. The controller 15 may control autonomous operation based on the operation plan received from the operation management apparatus 30.

(Configuration of Information Processing Apparatus)

Next, configurations of the information processing apparatus 20 will be described in detail. As illustrated in FIG. 1, the information processing apparatus 20 includes an input interface 21, a communication interface 22, a memory 23, and a controller 24. The information processing apparatus 20 assigns a parking lot to the vehicle 10.

The input interface 21 is configured to include at least one interface for input that is capable of accepting an operation plan and the like for the vehicle 10 from the operation management apparatus 30.

The communication interface 22 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 accepts the parking reservation and the operation plan for the vehicle 10 from the operation management apparatus 30 via the communication interface 22 and the network 2. The information processing apparatus 20 transmits a notification of completion of reservation or a notification of change in reservation for the vehicle 10 to the operation management apparatus 30 via the communication interface 22 and the network 2.

The memory 23 includes one or more memories. The memories included in the memory 23 may each function as, for example, a main memory, an auxiliary memory, or a cache memory. The memory 23 stores any information to be used for the operations of the information processing apparatus 20. For example, the memory 23 may store a system program, an application program, and a database, along with positional information (map information) and the operation plan for the vehicle 10, and the like. The information stored in the memory 23 may be updated with, for example, information acquired from the network 2 via the communication interface 22.

The controller 24 includes at least one processor, at least one programmable circuit, at least one dedicated circuit, or a combination of these. The controller 24 controls the operations of the entire information processing apparatus 20.

(Configuration of Operation Management Apparatus)

As illustrated in FIG. 1, the operation management apparatus 30 includes an input interface 31, a communication interface 32, a memory 33, and a controller 34.

The input interface 31 is configured to include at least one interface for input that is capable of accepting a notification of completion of reservation, a notification of change in reservation, and the like for the vehicle 10 transmitted from the information processing apparatus 20.

The communication interface 32 is configured to include at least one communication module for connection to the network 2. The communication module is, for example, a communication module compliant with a communication standard such as LTE, 4G, 5G, or CAN. However, the communication module is not limited to this. The communication module may be compliant with any communication standard. In the present embodiment, the operation management apparatus 30 transmits the parking reservation, operation plan, and the like for the vehicle 10 to the information processing apparatus 20, and receives a notification of completion of reservation, a notification of change in reservation, and the like for the vehicle 10 transmitted from the information processing apparatus 20, via the communication interface 32 and the network 2.

The memory 33 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 33 may function as a main memory, an auxiliary memory, or a cache memory.

The controller 34 includes at least one processor, at least one programmable circuit, at least one dedicated circuit, or a combination of these. The controller 34 controls the operations of the entire operation management apparatus 30.

(Flow of Operations of Information Processing Apparatus 20)

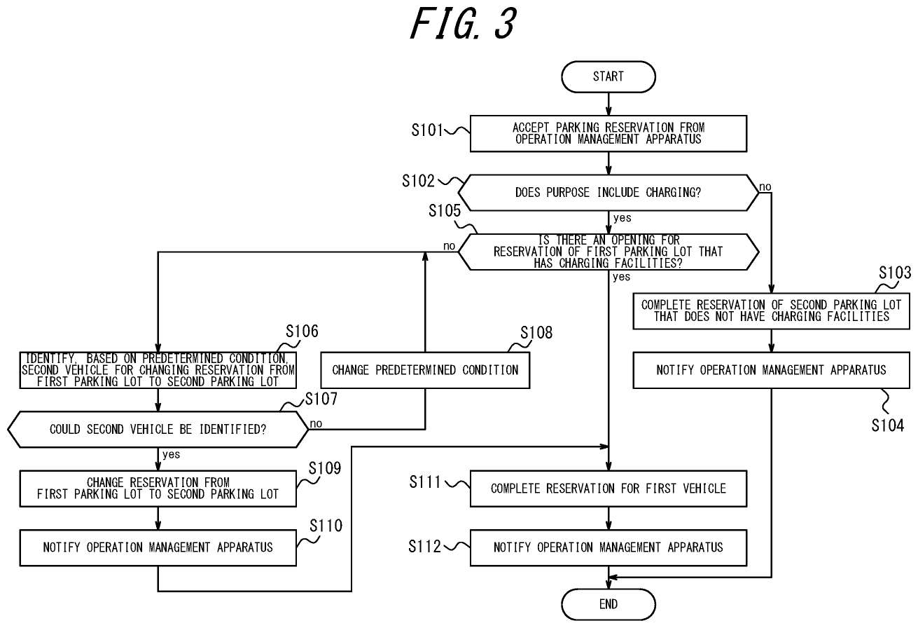

Operations of the information processing apparatus 20 according to the present embodiment will be described with reference to FIG. 3.

Step S101: the input interface 21 of the information processing apparatus 20 accepts a parking reservation for the vehicle 10 for which parking is desired from the operation management apparatus 30.

When accepting a parking reservation for a vehicle 10 for which parking is desired, the input interface 21 acquires an operation plan for the vehicle 10 for which parking is desired. The operation plan includes at least one piece of information from among a vehicle size, a desired parking time slot, a purpose for parking, an operation route, an expected number of passengers, a vehicle weight, an expected remaining charge at a scheduled time for start of parking, and an expected power consumption indicating an electrical energy expected to be consumed within a predetermined period (such as within a period from the scheduled time for the end of parking until 24:00 on the day after the end of parking).

Step S102: the controller 24 of the information processing apparatus 20 confirms whether the purpose for parking of the vehicle 10 includes charging.

The purpose for parking in the present embodiment is for inspection, standby, maintenance, or the like, in addition to recharging. The purpose for parking is identified from the operation plan.

Step S103: the controller 24 of the information processing apparatus 20 completes the reservation by assigning the second parking lot Pa2, which does not have charging stations Cs, to the vehicle 10 whose purpose for parking does not include charging.

The controller 24 secures the second parking lot Pa2, which does not have charging stations Cs, on a priority basis in a case in which the purpose for parking of the vehicle 10 is a purpose other than charging, such as standby or maintenance, but may tentatively secure the first parking lot Pa1, which has charging stations, in a case in which there is space in the first parking lot Pa1. The controller 24 may also secure a parking space suitable for the vehicle size of the vehicle 10. The vehicle size may, for example, be classified as small passenger car, medium passenger car, large passenger car, bus, or truck. The vehicle size is identified from the operation plan.

Step S104: the communication interface 22 of the information processing apparatus 20 transmits, to the operation management apparatus 30, a notification of completion of reservation indicating that the reservation of the second parking lot Pa2 has been completed for the vehicle 10 whose purpose of parking does not include charging.

The notification of completion of reservation includes information including the location of the parking lot (for example, first parking lot Pa1 or second parking lot Pa2), a reservation ID, map information, reserved space number, reserved time slot, availability of charging stations, or the like. The reservation ID, for example, is an individual identification generated by the controller 24 of the information processing apparatus 20 when reservation of the parking lot is completed and may be formed by a series of numbers and characters.

Step S105: the controller 24 of the information processing apparatus 20 confirms whether there is an opening for reservation of the first parking lot Pa1 that has charging stations Cs in a case in which the vehicle 10 for which parking is desired is a first vehicle 10A whose purpose for parking includes charging.

When there is an opening for reservation of the first parking lot Pa1 that has charging stations Cs, the process advances to S111. Conversely, when there is no opening for reservation, the controller 24 first confirms whether a vehicle 10 whose purpose for parking does not include charging (no charging required) has secured the first parking lot Pa1. If a vehicle 10 that does not require charging has secured the first parking lot Pa1, then the parking lot Pa2, which is another parking lot, can simply be secured, and the reservation of the first parking lot Pa1 for the vehicle 10 can then be changed to the second parking lot Pa2. When such a change in reservation creates an opening in the first parking lot Pa1, the process advances to S111. However, when there is no opening for reservation of the first parking lot Pa1 that has charging stations Cs, and a vehicle 10 that does not need to be charged has not secured the first parking lot Pa1, the process advances to S106.

Step S106: the controller 24 of the information processing apparatus 20 identifies, based on a predetermined condition, as a second vehicle 10B at least one vehicle selected based on the predetermined condition from among one or more reservation holding vehicles for which acceptance of the reservation of the first parking lot Pa1 is completed.

The predetermined condition is a condition for identifying the second vehicle 10B. The predetermined condition is, for example, that (i) among reservation holding vehicles whose purpose for parking includes charging and whose desired parking time slot overlaps with the first vehicle 10A, at least one vehicle for which a first value yielded by subtracting the expected power consumption from the expected remaining charge is larger than the first value of the first vehicle 10A is identified as the second vehicle, and (ii) in a case in which no reservation holding vehicle with a larger first value than the first vehicle 10A exists, at least one vehicle, among the reservation holding vehicles, for which a second value yielded by dividing an amount of CO2 emitted to produce electricity used to charge the vehicle by the expected number of passengers is larger than the second value of the first vehicle 10A is identified as the second vehicle. The expected number of passengers is identified from the operation plan.

Step S107: the controller 24 of the information processing apparatus 20 confirms whether at least one second vehicle 10B has been identified. In the case of identification, the process advances to step S110; otherwise, the process advances to step S109.

The first value yielded by subtracting the expected power consumption from the expected remaining charge of the first vehicle 10A being smaller than the first value of a reservation holding vehicle means that the first vehicle 10A has a higher priority for charging. Since the expected remaining charge is the remaining charge at the scheduled time to start parking, and the expected power consumption is the electrical energy expected to be consumed within a predetermined period after the scheduled time for the end of parking, the first value signifies the remaining charge at the end of the predetermined period in a case in which no charging at all is performed during the desired parking time slot. Therefore, the smaller the first value of the vehicle, the higher the priority for charging.

The second value is a value yielded by dividing the amount of CO2 emitted to produce electricity used to charge the vehicle by the expected number of passengers. Therefore, the second value of the first vehicle 10A being smaller than the second value of a reservation holding vehicle means that in the case of operating the first vehicle 10A, the CO2 emission per passenger is lower, and the environmental impact is smaller. The environmental impact refers to the negative impact on the environment.

Step S108: the controller 24 of the information processing apparatus 20 changes the predetermined condition. After the predetermined condition is changed, the process returns to step S106.

The controller 24 may change the predetermined condition to any of (i) through (iii) below in a case in which there is no reservation holding vehicle whose first value and second value are larger than those of the first 10A vehicle. (i) For example, among reservation holding vehicles whose purpose for parking includes charging and whose desired parking time slot overlaps with the first vehicle 10A, at least one vehicle with a larger expected remaining charge than the expected remaining charge of the first vehicle 10A may be identified as the second vehicle. This is a condition that emphasizes the priority of charging. (ii) Also, for example, among reservation holding vehicles for which the amount of CO2 emitted to produce electricity used to charge the vehicle is approximately the same, at least one vehicle whose electricity cost is greater than the electricity cost of the first vehicle 10A may be identified as the second vehicle. The electricity cost is equivalent to the gas mileage (fuel consumption rate) in gasoline-powered vehicles and refers to the distance that can be traveled per unit of electrical energy in BEVs and the like. Vehicles with a good electricity cost have reduced environmental impact. (iii) Furthermore, among reservation holding vehicles for which the amount of CO2 emitted to produce electricity used to charge the vehicle is approximately the same, at least one vehicle whose vehicle weight is greater than the vehicle weight of the first vehicle 10A may be identified as the second vehicle. The reason is that a lighter vehicle weight has less environmental impact.

Step S109: the controller 24 of the information processing apparatus 20 changes the reservation of the first parking lot Pa1 for the second vehicle 10B to a reservation of the second parking lot Pa2.

Since a vehicle 10 identified as the second vehicle 10B has secured a reservation of the first parking lot Pa1, the parking lot Pa2, which is another parking lot, can be secured, and the reservation of the first parking lot Pa1 for the second vehicle 10B can then be changed to the second parking lot Pa2. The controller 24 may also change the parking time of the second vehicle 10B in the first parking lot Pa1 so that the first vehicle 10A can reserve the first parking lot Pa1 during the desired parking slot.

Step S110: the communication interface 22 of the information processing apparatus 20 transmits, to the operation management apparatus 30, a notification of change in reservation indicating that the reservation of the first parking lot Pa1 for the vehicle 10 identified as the second vehicle 10B has been changed to a reservation of the second parking lot Pa2.

The notification of change in reservation includes information including the location of the parking lot (for example, second parking lot Pa2), a reservation ID, map information, reserved space number, reserved time slot, availability of charging stations, or the like.

Step S111: the controller 24 of the information processing apparatus 20 completes the acceptance of the reservation of the first parking lot Pa1 for the first vehicle 10A.

The controller 24 completes the acceptance of the reservation of the first parking lot Pa1 for the first vehicle 10A in conjunction with the release of the reservation of the first parking lot Pa1 that was reserved for the vehicle 10 identified as the second vehicle 10B.

Step S112: the communication interface 22 of the information processing apparatus 20 transmits, to the operation management apparatus 30, a notification of completion of reservation indicating that the reservation of the first parking lot Pa1 has been completed for the first vehicle 10A.

The notification of completion of reservation includes information including the location of the parking lot (first parking lot Pa1), a reservation ID, map information, reserved space number, reserved time slot, availability of charging stations, or the like.

As described above, in a case in which the vehicle 10 for which parking is desired is a first vehicle 10A whose purpose for parking includes charging, the information processing apparatus 20 according to the present embodiment confirms whether there is an opening for reservation of the first parking lot Pa1 that has charging stations Cs, completes acceptance of reservation of the first parking lot Pa1 for the first vehicle 10A when there is an opening for reservation, and identifies, based on a predetermined condition, at least one vehicle, selected based on the predetermined condition from among one or more reservation holding vehicles for which acceptance of the reservation of the first parking lot Pa1 is completed, as a second vehicle 10B when there is no opening for reservation. The information processing apparatus 20 then changes a reservation of the first parking lot Pa1 for the second vehicle 10B to a reservation of the second parking lot Pa2 and completes acceptance of reservation of the first parking lot Pa1 for the first vehicle 10A.

According to such a configuration, the information processing apparatus 20 can assign vehicles whose purpose is inspection, maintenance, or standby, or vehicles with low priority for charging, along with vehicles with high priority for charging to the most appropriate parking lot at the time of reservation. Therefore, compared to the case in which a reservation of the first parking lot Pa1 that has charging stations Cs is determined simply on a first-come, first-served basis for vehicles 10 for which parking reservations are accepted, the probability of inconveniences is reduced, such as waiting time occurring because a vehicle with a high priority for charging cannot park in the first parking lot Pa1 that has charging stations. In this respect, the technology for determining the parking lot to assign when a parking reservation is accepted is improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment may also be implemented in which the configuration and operations of the operation management apparatus 30 are distributed to a plurality of operation management apparatuses 30 that can communicate with each other, and each apparatus manages vehicles 10 in a district for which the apparatus is responsible. As another example, an embodiment in which some or all of the components of the information processing apparatus 20 are provided in the operation management apparatus 30 can also be implemented.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

In the above-described configuration, a case in which parking reservations are accepted in order starting with one first vehicle 10A is assumed. However, in a case in which there is only one available reservation for the first parking lot Pa1 or a case in which only one second vehicle 10B can be identified, if parking reservations are accepted simultaneously from two or more first vehicles 10A with overlapping desired parking time slots, the reservations for the first vehicles 10A will conflict. Consequently, it will be impossible to complete the reservations for all of the first vehicles 10A.

In such cases, the controller 24 may identify one first vehicle 10A, among two or more first vehicles 10A, for which to prioritize parking in the first parking lot Pa1 based on the above-described predetermined condition. Similarly, in a case in which two or more reservations are available, two or more first vehicles 10A may be identified based on the predetermined condition. This configuration improves the technology for determining the parking lot to assign when a parking reservation is accepted in that the probability of inconveniences is reduced, such as waiting time occurring because the vehicle with highest priority for charging among two or more first vehicles 10A cannot park in the first parking lot Pa1 that has charging stations.

1. An information processing apparatus for assigning a parking lot to a vehicle, the information processing apparatus comprising:
an input interface configured to accept a parking reservation for a vehicle for which parking is desired; and
a controller configured to confirm, in a case in which the vehicle for which parking is desired is a first vehicle whose purpose for parking includes charging, whether there is an opening for reservation of a first parking lot having a charging station, complete acceptance of a reservation of the first parking lot for the first vehicle when there is an opening for reservation, identify, based on a predetermined condition, as a second vehicle at least one vehicle selected based on the predetermined condition from among one or more reservation holding vehicles for which acceptance of the reservation of the first parking lot is completed when there is no opening for reservation, change the reservation of the first parking lot for the second vehicle to a reservation of a second parking lot, and complete acceptance of the reservation of the first parking lot for the first vehicle.

2. The information processing apparatus according to claim 1, wherein
the input interface is configured to acquire an operation plan for the vehicle for which parking is desired when accepting the parking reservation, and
the operation plan includes at least one piece of information from among a vehicle size of the vehicle for which parking is desired, a desired parking time slot, a purpose for parking, an operation route, an expected number of passengers, a vehicle weight, an expected remaining charge at a scheduled time for start of parking, and an expected power consumption indicating an electrical energy expected to be consumed within a predetermined period after a scheduled time for end of parking.

3. The information processing apparatus according to claim 2, wherein the predetermined condition is that among reservation holding vehicles whose purpose for parking includes charging and whose desired parking time slot overlaps with the first vehicle, at least one vehicle for which a first value yielded by subtracting the expected power consumption from the expected remaining charge is larger than the first value of the first vehicle is identified as the second vehicle, and in a case in which no reservation holding vehicle with a larger first value than the first vehicle exists, at least one vehicle, among the reservation holding vehicles, for which a second value yielded by dividing an amount of CO2 emitted to produce electricity used to charge the vehicle by the expected number of passengers is larger than the second value of the first vehicle is identified as the second vehicle.

4. An information processing method for assigning a parking lot to a vehicle, the information processing method comprising:
accepting a parking reservation for a vehicle for which parking is desired;
confirming, in a case in which the vehicle for which parking is desired is a first vehicle whose purpose for parking includes charging, whether there is an opening for reservation of a first parking lot having a charging station;
completing acceptance of a reservation of the first parking lot for the first vehicle when there is an opening for reservation;
identifying, based on a predetermined condition, as a second vehicle at least one vehicle selected based on the predetermined condition from among one or more reservation holding vehicles for which acceptance of the reservation of the first parking lot is completed when there is no opening for reservation;
changing the reservation of the first parking lot for the second vehicle to a reservation of a second parking lot; and
completing acceptance of the reservation of the first parking lot for the first vehicle.

5. A non-transitory computer readable medium storing a program configured to cause an information processing apparatus for assigning a parking lot to a vehicle to execute operations, the operations comprising:
accepting a parking reservation for a vehicle for which parking is desired;
confirming, in a case in which the vehicle for which parking is desired is a first vehicle whose purpose for parking includes charging, whether there is an opening for reservation of a first parking lot having a charging station;
completing acceptance of a reservation of the first parking lot for the first vehicle when there is an opening for reservation;
identifying, based on a predetermined condition, as a second vehicle at least one vehicle selected based on the predetermined condition from among one or more reservation holding vehicles for which acceptance of the reservation of the first parking lot is completed when there is no opening for reservation;
changing the reservation of the first parking lot for the second vehicle to a reservation of a second parking lot; and
completing acceptance of the reservation of the first parking lot for the first vehicle.
